(19) United States
(12) Patent Application Publication
(10) Pub. No.: US 2003/0188275 A1
(43) Pub. Date: Oct. 2, 2003

(54) System and method of preventing the simulation of a circuit if a change to the circuit topology is detected

(76) Inventor: Lawrence G. Meares, Rancho Palos Verdes, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/112,320

(22) Filed: Mar. 27, 2002

(51) Int. Cl. G06F 17/50

(52) U.S. Cl. 716/4; 716/1

(57) ABSTRACT

A system, method, and software module for preventing a simulation and/or analysis of a circuit described in a netlist if a change in the circuit topology has been detected. The method entails scanning the netlist for circuit topology changes prior to performing the simulation or analysis on the circuit. If no change in the circuit topology has been detected, then the simulation or analysis of the circuit is allowed to proceed. If, on the other hand, a change in the circuit topology has been detected, then in some cases the simulation and/or analysis of the circuit is prevented. The methodology allows a prospective customer to perform simulation and/or analysis on a complicated circuit with a freely-distributed demo simulation program, and yet it does not rise to the software manufacturing giving away its software since the simulation and/or analysis is restricted to that particular circuit topology.

### FIELD OF THE INVENTION

This invention relates generally to circuit simulation software programs, and in particular, to a system and method of preventing the simulation and/or analysis of a circuit described in a netlist if a change to the circuit topology is detected.

### BACKGROUND OF THE INVENTION

The cost of designing and producing circuits is expensive. Accordingly, engineers need to ensure that their circuits operate according to their intended design. A number of computer applications have been developed which allow design engineers to simulate their circuits prior to actually incurring the cost of production. Some of these computer-aided engineering applications are based on “SPICE”, which was first developed by the University of California at Berkeley and later refined by a number of institutions, including the Georgia Institute of Technology. The SPICE-based applications provide design engineers with the necessary tools to create, test, and simulate circuits on a computer.

There are many manufacturers that market and sell SPICE-based applications. One marketing tool, which has become popular with software manufacturers, is to provide a free demonstration version (“demo”) of the software to prospective customers. Thus, generally SPICE program manufacturers distribute as a marketing tool demos of SPICE-based software programs. Most SPICE program demos are capable of simulating a circuit described in an input netlist. However, they typically limit the complexity of the circuit that can be simulated. For example, SPICE demos may limit the simulation of circuit having at most a few components and/or a few nodes.

Recently, IC manufacturers have requested SPICE demos that are capable of simulating large-scale circuits, such as a complex circuit typically formed as an integrated circuit. That is, IC manufacturers have expressed the desire to show case their entire integrated circuit product line using a SPICE demo program. This benefits the software manufacturer because they share the same customer base with the IC manufacturer. However, increasing the complexity limit of the circuit that can be simulated in a SPICE demo to accommodate the simulation of integrated circuits would amount to the software manufacturers giving away their SPICE programs.

Thus, there is a need for a system, method, and software program that allows a prospective customer to simulate a complex circuit using demo simulation program, while at the same time, restricting its use so as not to essentially give away the full capability of its circuit simulation product.

### SUMMARY OF THE INVENTION

An aspect of the invention relates to a method of preventing a simulation and/or analysis of a circuit described in a netlist if a change in the circuit topology has been detected. The method entails scanning the netlist for circuit topology changes prior to performing the simulation or analysis on the circuit. If no change in the circuit topology has been detected, then the simulation or analysis of the circuit is allowed to proceed. If, on the other hand, a change in the circuit topology has been detected, then in some cases the simulation and/or analysis of the circuit is prevented. The methodology allows a prospective customer to perform simulation and/or analysis on a complicated circuit with a freely-distributed demo simulation program, and yet it does not rise to the software manufacturing giving away its software since the simulation and/or analysis is restricted to that particular circuit topology.

A more detailed embodiment of the method in accordance with the invention involves the software manufacturer (or other entity) receiving from the IC manufacturer (or other entity) a proposed netlist of a circuit it wishes to simulate and/or analyze with a demo simulation program. The software manufacture, in turn, performs a mathematical algorithm on at least a portion of the circuit topology parameters of the netlist to generate a reference value (or values). The reference value, which could be a hash value (i.e. a value resulting from a hashing operation performed on a piece of data), is placed in the netlist as an argument to a call function. The call function, when executed by the demo simulation software, performs a similar (inverse) mathematical algorithm to determine whether the circuit topology has changed.

After the software manufacturer encodes the netlist with the circuit topology change-detect call function, the software manufacturer sends the encoded netlist to the prospective customer and/or the IC manufacturer who in turn distributes the encoded models to their customers. The prospective customer then runs the demo simulation software with the encoded netlist. The demo simulation program in accordance with the invention recognizes and processes the circuit topology change-detect call function. When this function is executed, a mathematical algorithm is performed on the same circuit topology parameters to generate a test value. If the circuit topology has not been changed, the resulting test value is the same as the reference value. Thus, the demo simulation software generates the test value and compares it with the reference value. If it is the same, the requested simulation and/or analysis of the circuit is allowed to proceed. If it is not the same, in some cases the requested simulation and/or analysis of the circuit will not be allowed to proceed.

Other aspects of the invention include a system including a processor that implements the aforementioned methodology and a computer readable medium including one or more software modules that also implements the aforementioned methodology. Other aspects, features and techniques of the invention will become apparent to one skilled in the relevant art in view of the following detailed description of the invention.

### BRIEF DESCRIPTION OF THE DRAWINGS

FIG. 1A illustrates a perspective view of an exemplary computer system in accordance with an embodiment of the invention;

FIG. 1B illustrates a block diagram of an exemplary processor system in accordance with another exemplary embodiment of the invention;

FIG. 2 illustrates a flow diagram of an exemplary method of preventing the simulation of a circuit if a change to the circuit topology is detected in accordance with another exemplary embodiment of the invention;

FIG. 3A illustrates a flow diagram of an exemplary method of encoding a circuit netlist to prevent the simulation of the circuit if a circuit topology change is detected in accordance with another exemplary embodiment of the invention;

FIG. 3B illustrates an exemplary circuit netlist prior to undergoing the encoding in accordance with the exemplary embodiment of the invention;

FIG. 3C illustrates an exemplary circuit netlist after undergoing the encoding in accordance with the exemplary embodiment of the invention;

FIG. 4 illustrates a flow diagram of an exemplary method of preventing the simulation of a circuit if a change to the circuit topology is detected in accordance with yet another exemplary embodiment of the invention; and

FIG. 5 illustrates a functional block diagram of an exemplary system of preventing the simulation of a circuit if a change to the circuit topology is detected in accordance with still another exemplary embodiment of the invention.

### DETAILED DESCRIPTION OF THE INVENTION

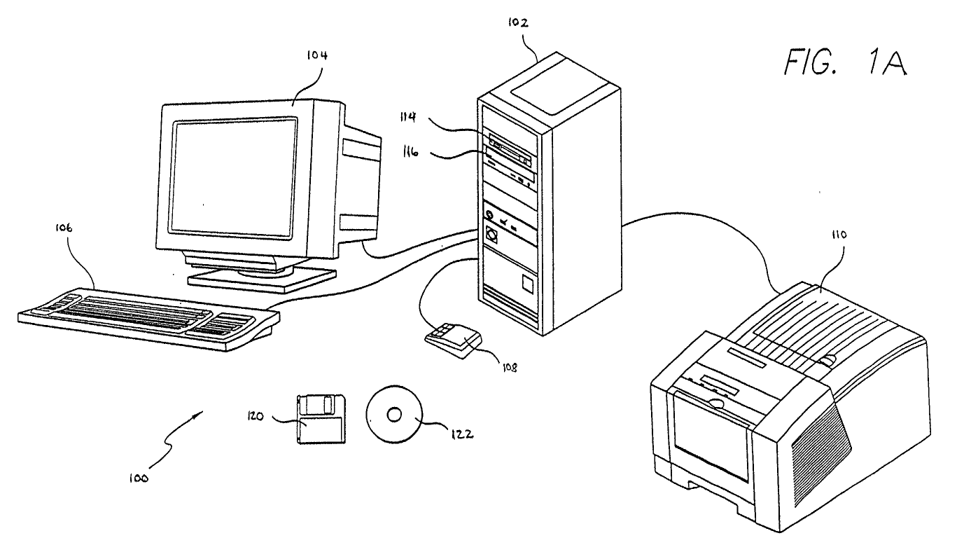

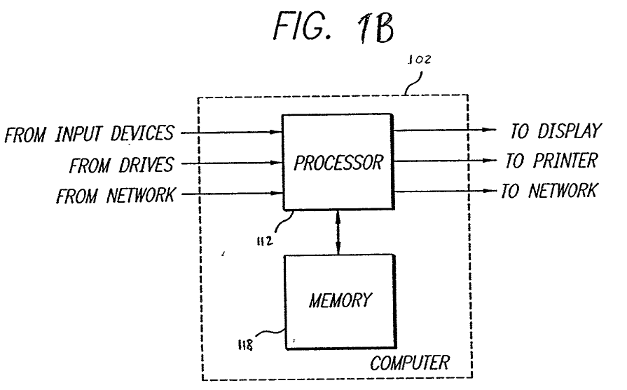

FIG. 1A illustrates a perspective view of an exemplary computer system 100 that can implement the methodology of the invention. The computer system 100 comprises a computer 102, a display 104, one or more input/output devices such as a keyboard 106 and/or pointer device 108, and a printer 110. The computer system 100 may have non-volatile memory storage devices such as a floppy disk drive 114 for reading data stored in a floppy disk 120 and/or an optical disc reader 116 (e.g. CD, DVD, or other format reader) for reading data stored in an optical disc 122.

FIG. 1B illustrates a block diagram of the exemplary computer 102 in accordance with the invention. The computer 102 comprises a processor 112 and a memory (e.g. random access memory). The processor 112 receives data from the input devices 106 and/or 108, drives 114 and 116, and network, processes the data in accordance with the methodology of the invention, and provides output data to the display 104, printer 110, and to the network. The memory 118 is used to store software programs and data for use by the processor 112 in performing the various methodology of the invention described herein.

As previously discussed in the Background section, IC manufacturerers have expressed the desire for circuit simulation program demos that can simulate their integrated circuit designs for their prospective customers. However, increasing the complexity limit on demo software to accommodate the simulation of such large scale circuits would amount to the software manufacturer giving away their software. The system and method of the invention solve this problem by preventing the simulation of the circuit if the circuit topology has changed. In this way, the prospective customer can show case their integrated circuit design using the demo software. At the same time, the software manufacturer has not given away their simulation software since it does not give the prospective customers permission to change the circuit topology, thereby rendering the demo software useless for circuit development. The following flowchart illustrates this concept in more detail.

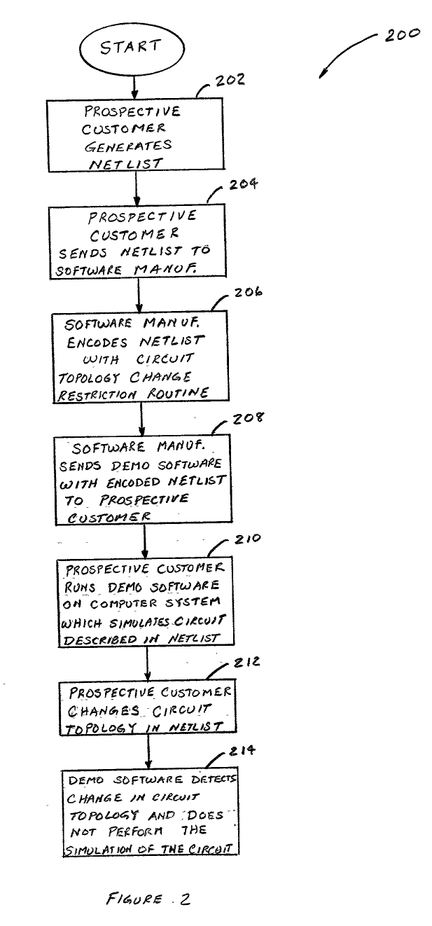

FIG. 2 illustrates a flow diagram of an exemplary method 200 of preventing the simulation of a circuit if a change to the circuit topology is detected in accordance with another exemplary embodiment of the invention. In step 202, a prospective customer using a computer system, such as like the one shown in FIGS. 1A-B, generates a netlist for a circuit (which may include a plurality of subcircuits) to be simulated by the demo circuit simulation program in accordance with the invention. In step 204, the prospective customer sends the netlist to the software manufacturer.

In step 206, the software manufacturer using a computer system, such as like the one described with reference to FIGS. 1A-B, encodes the netlist with a call function that when executed causes the scanning of the netlist for the circuit to determine whether there has been a change to the circuit topology. If the circuit topology has changed, then the simulation of the circuit or subcircuit is not performed. In step 208, the software manufacturer sends the encoded netlist to the IC manufacturer and/or prospective customer.

In step 210, the prospective customer using a computer system, such as like the one described with reference to FIGS. 1A-B, runs the demo software to simulate or perform an analysis of the circuit described in the encoded netlist. In step 212, the prospective customer changes the circuit topology described in the encoded netlist. In step 214, the prospective customer attempts to cause another simulation of the circuit. However, the execution of the function encoded in the netlist causes the demo software to scan the netlist of the circuit for circuit topology change. If change is detected, the demo software does not perform the simulation or analysis of the circuit or subcircuit. Alternatively, if the circuit does not exceed the complexity limit of the demo simulation program, then the simulation or analysis of the circuit may be performed.

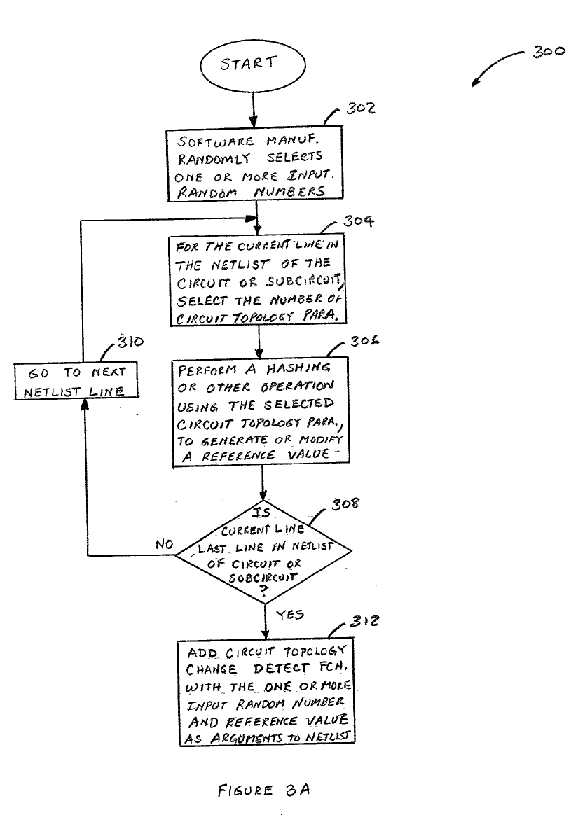

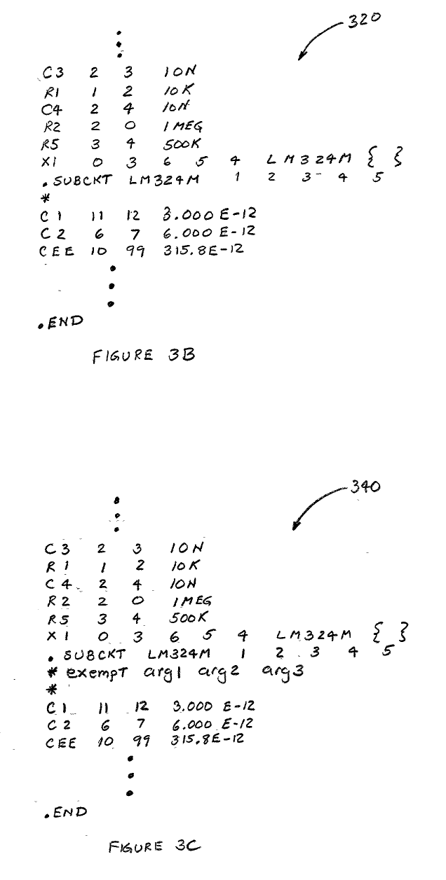

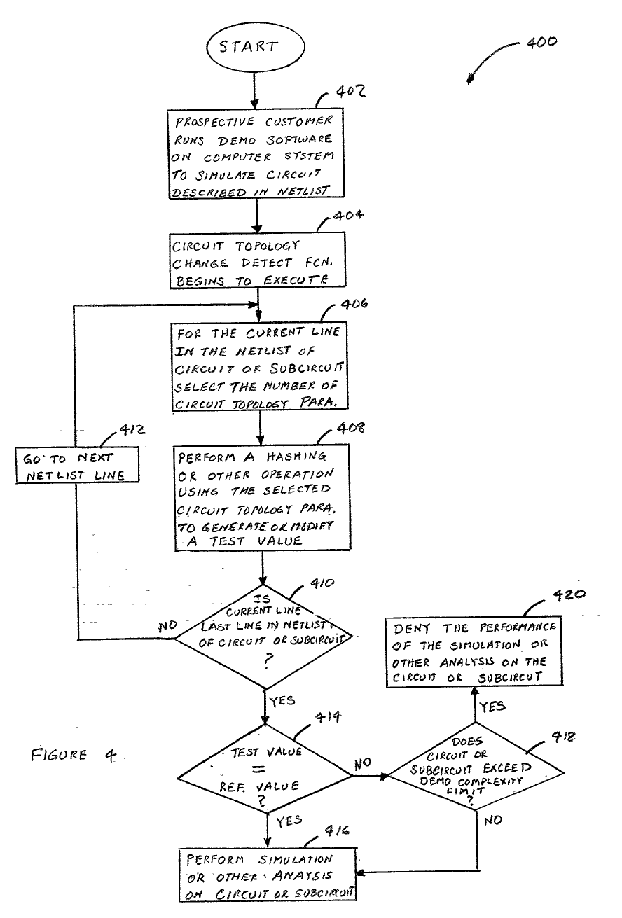

FIG. 3A illustrates a flow diagram of an exemplary method 300 of encoding a circuit netlist for the purpose of preventing the simulation of the circuit if a circuit topology change is detected in accordance with another exemplary embodiment of the invention. In step 302, the software manufacture selects one or more random numbers which are used to select the number of circuit topology parameter of each line of the netlist used for the encoding process. For example, the input random numbers can be used as inputs to a psuedo random number generator to generate a random number from 1 to 3 (i.e. the lowest to highest number of circuit topology parameters in a netlist line).

In step 306, a hashing or other mathematical operation is performed on the selected circuit topology parameter to generate or modify a reference value. In step 308, an inquiry is made as to whether the current line is the last line in the netlist of the circuit. If it is not, in step 310 the next line in the netlist becomes the current line, and steps 304 and 306 are repeated. If in step 308 the current line is the same as the last line in the netlist, in step 312 a circuit topology change-detect function is added to the netlist. The circuit topology change-detect function has as arguments the one or more input random numbers and the final reference value accumulated when steps 304 and 306 are repeated for all the lines in the netlist of the circuit. Thus, the final reference value serves to represent the original circuit topology.

FIG. 3B illustrates an exemplary partial netlist 320 prior to undergoing the encoding in accordance with the exemplary embodiment of the invention. In this example, it is assumed that the encoding is done for the subcircuit LM324M defined in the netlist 320. It shall be understood that the encoding can be performed for the entire circuit, or one or more subcircuits defined in the netlist. The first circuit topology line is given by the following:

| | | | |
|---|---|---|---|
| C1 | 11 | 12 | 3.000E−12 |

The first line therefore has three (3) parameters that relate to the circuit topology, C1 indicates a capacitor, and 11-12 indicate the nodes to which capacitor C1 is connected. The 3.000E-12 is the value of the capacitor C1, so it does not relate to the circuit topology. Similarly, the circuit topology parameters of the second and third lines of the subcircuit LM324M are as follows:

| | | |
|---|---|---|
| C2 | 6 | 7 |
| CEE | 10 | 99 |

Thus, and referring also to FIG. 3A, in step 304 the first (i.e. C1), the second (i.e. 11), and/or the third (i.e. 12) circuit topology parameters of the first netlist line in subcircuit LM324M may be selected to undergo the hashing process of step 306 in accordance with the invention. Similarly, in step 304 one or more respective circuit topology parameters for the second line (i.e. C2, 6 and/or 7) and third line (i.e. CEE, 10, and/or 99) of the subcircuit LM324M netlist may be selected to undergo the hashing process of step 306 in accordance with the invention.

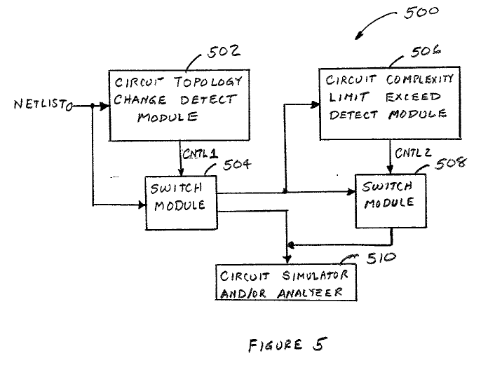

FIG. 3C illustrates an exemplary partial netlist 340 after undergoing the encoding in accordance with the exemplary embodiment of the invention. The encoded partial netlist 340 is the same as the original partial netlist 320, except that the circuit topology change-detect call function has been added to the partial netlist 320 after the .subckt LM324M line. An example of how the circuit topology change detect call function may be defined is as follows:

| | | | |
|---|---|---|---|
| *exempt | arg1 | arg2 | arg3 |

where *exempt defines the call function, arg1-2 define the input random numbers used for selecting the number of circuit topology parameters to undergo the hashing process, and arg3 defines the resulting hash value for the circuit topology. As will be discussed with reference to FIG. 4, when the demo simulation software encounters the circuit topology change-detect call function, a scanning of the circuit topology described in the netlist occurs to determine if a change has occurred before a simulation and/or analysis is performed on the circuit.

FIG. 4 illustrates a flow diagram of an exemplary method 400 of preventing the simulation of a circuit if a change to the circuit topology is detected in accordance with yet another exemplary embodiment of the invention. In step 402, the prospective customer runs the demo simulation program on a computer system, such as the one described with reference to FIGS. 1A-B, to simulate the circuit described in the encoded netlist. In step 404, the demo simulation program causes the execution of the circuit topology detect function, e.g. *exempt arg1arg2 arg3. In accordance with the circuit topology detect function, in step 406 one or more circuit topology parameters for the current netlist line are selected according to the arguments arg1 and arg2 of the *exempt function. In step 408, the selected circuit topology parameters undergo a hashing operation to generate or modify a test value.

In step 410, an inquiry is made as to whether the current line is the last line in the netlist. If it is not, in step 412 the next line is made the current line and steps 406 and 408 are repeated. If in step 410 the current line is the last line in the netlist, the method 400 proceeds to step 414 where another inquiry is made as to whether the test value is equal to the reference or hash value. If in step 414 it is determined that the test value equals the reference or hash value, which implies that the circuit topology has not changed, the method 400 proceeds to step 416 to perform the desired simulation or analysis on the circuit. If in step 414 the test value does not equal to the reference or hash value, which implies that the circuit topology has changed, the method 400 proceeds to step 418 where an inquiry is made as to whether the netlist of the circuit exceeds the demo complexity limit. If it does not, the method proceeds to step 416 to perform the desired simulation or analysis on the circuit or subcircuit. If in step 418, the netlist exceeds the demo complexity limit, the method denies the performance of the simulation or other analysis on the circuit or subcircuit.

In summary, the method 400 performs a similar hashing algorithm as was done during the encoding of the netlist to determine whether the circuit topology has changed. If the netlist has not changed, the simulation or other analysis on the circuit is performed. If the circuit topology has changed, then a determination is made as to whether the circuit exceeds the demo complexity limit. If it has not, the simulation or other analysis on the circuit is performed. If it has, simulation or analysis of the circuit is denied. The method allows an IC manufacturer to simulate a large scale circuit (e.g. an integrated circuit) to allow it to showcase their product. However, if the prospective customer changes the circuit topology of the large scale circuit, the simulation is denied. This protects the software manufacture from essentially giving away their simulation software product. At the same time, the method 400 allows changes to the circuit topology if the circuit does not exceed the demo circuit complexity limit. This makes the method 400 compatible with existing demo simulation software which provide simulation of small circuits.

FIG. 5 illustrates a functional block diagram of an exemplary system 500 of preventing the simulation of a circuit if a change to the circuit topology is detected in accordance with another embodiment of the invention. The system 500 comprises a circuit topology change detect module 502, a two-pole-one-throw switch module 504, a circuit complexity limit exceed detect module 506, a single-pole-single-throw switch module 508, and a circuit simulator and/or analyzer module 510.

In operation, a netlist is sent to the switch module 504 and the circuit topology change detect module 502 to determine if the circuit topology has changed. If no change in the circuit topology has been detected, the module 502 sends a control signal CNTL1 to the switch module 502 to couple the netlist to the circuit simulator and/or analyzer module 510. If, on the other hand, a change in the circuit topology has been detected, the module 502 sends a control signal CNTL1 to the switch module 502 to couple the netlist to the switch module 508 and the circuit complexity limit exceed detect module 506. If the netlist does not exceed the complexity limit, the module 506 sends a signal CNTL2 to the switch module 508 to couple the netlist to the circuit simulator and/or analyzer module 510. If, on the other hand, the netlist does exceed the complexity limit the modules 506 does not send the signal CNTL2 to the switch module 508, thereby preventing the simulation or analysis of the circuit.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

It is claimed:

1. A method, comprising:
receiving a netlist that describes a circuit; and
adding a function to said netlist to prevent a simulation and/or analysis of said circuit if a change in the topology of said circuit is detected.

2. The method of claim 1, wherein adding said function comprises:
generating.a reference value which is dependent on said topology of said circuit; and
adding said function to said netlist with said reference value as an argument to said function.

3. The method of claim 2, wherein generating said reference value comprises performing a hash operation on at least a portion of circuit topology parameters of said netlist.

4. The method of claim 2, wherein generating said reference value comprises:
selecting one or more circuit topology parameters from each line of said netlist; and
using said selected one or more circuit topology parameters of each line of said netlist as inputs to a mathematical algorithm to generate said reference value.

5. The method of claim 4, wherein selecting one or more circuit topology parameters from each line of said netlist is performed in a pseudo random fashion.

6. A method, comprising:
receiving a netlist that describes a circuit;
determining whether said topology of said circuit has changed;
performing a circuit simulation and/or analysis of said circuit in response to determining that said topology of said circuit has not changed; and
denying a circuit simulation and/or analysis of said circuit in response to determining that said topology of said circuit has changed.

7. The method of claim 6, wherein said netlist comprises a function used to detect whether said topology of said circuit has been changed.

8. The method of claim 7, wherein said function includes a first argument used to select circuit topology parameters from each line of said netlist and a second argument that serves as a reference value indicative of an original circuit topology for said netlist.

9. The method of claim 8, wherein determining whether said topology of said circuit has changed comprises:
using said first argument to select one or more circuit topology parameters from each line of said netlist;
performing a mathematical operation on said selected one or more circuit topology parameters from each line of said netlist to generate a test value; and
comparing said test value with said reference value to determine whether said circuit topology has changed.

10. The method of claim 9, wherein said first argument is used as an input to a pseudo random number generator which generates a number used to select the number of circuit topology parameters for each of said line of said netlist.

11. The method of claim 9, wherein said mathematical operation comprises a hashing operation.

12. The method of claim 6, further comprising:
determining whether the number of components and/or nodes in said netlist is below and/or above a predetermined limit;
performing said circuit simulation and/or analysis of said circuit in response to determining that the number of components and/or nodes in said netlist is below said predetermined limit; and
denying said circuit simulation and/or analysis of said circuit in response to determining that the number of components and/or nodes in said netlist is above said predetermined limit.

13. A computer readable medium storing one or more software modules to add a function to said netlist that prevents a simulation and/or analysis of said circuit if a change in the topology of said circuit is detected.

14. The computer readable medium of claim 13, wherein said one or more software modules:
generates a reference value dependent on said topology of said circuit; and
adds said function to said netlist with said reference value as an argument to said function.

15. The computer readable medium of claim 14, wherein said one or more software modules generates said reference value by performing a hash operation on at least a portion of circuit topology parameters of said netlist.

16. The computer readable medium of claim 14, wherein said one or more software modules generates said reference value by:
selecting one or more circuit topology parameters from each line of said netlist; and
using said one or more circuit topology of each line of said netlist as inputs to a mathematical algorithm to generate said reference value.

17. The computer readable medium of claim 16, wherein said one or more software modules selects one or more circuit topology parameters from each line of said netlist in a pseudo random fashion.

18. A computer readable medium storing one or more software modules to:
determine whether a topology of a circuit described in a netlist has changed;
perform a circuit simulation and/or analysis of said circuit in response to determining that said topology of said circuit has not changed; and
denying a circuit simulation and/or analysis of said circuit in response to determining that said topology of said circuit has changed.

19. The computer readable medium of claim 18, wherein said one or more software modules executes a function in said netlist to cause said determination of whether said topology of said circuit has been changed.

20. The computer readable medium of claim 19, wherein said function includes a first argument that serves to select circuit topology parameters from each line of said netlist and a second argument that serves as a reference value indicative of an original circuit topology for said netlist.

21. The computer readable medium of claim 20, wherein said one or more software modules determines whether said topology of said circuit has changed by:
using said first argument to select one or more circuit topology parameters from each line of said netlist;
performing a mathematical operation on said selected one or more circuit topology parameters from each line of said netlist to generate a test value; and
comparing said test value with said reference value to determine whether said circuit topology has changed.

22. The computer readable medium of claim 21, wherein said one or more software modules uses said first argument as an input to a pseudo random number generator to generate a number used to select the number of circuit topology parameters for each of said line of said netlist.

23. The computer readable medium of claim 21, wherein said mathematical operation comprises a hashing operation.

24. The computer readable medium of claim 18, wherein said one or more software modules:
determines whether the number of components and/or nodes in said netlist is below and/or above a predetermined limit;
performs said circuit simulation and/or analysis of said circuit in response to determining that the number of components and/or nodes in said netlist is below said predetermined limit; and
denying said circuit simulation and/or analysis of said circuit in response to determining that the number of components and/or nodes in said netlist is above said predetermined limit.

25. An apparatus including a processor to add a function to a netlist that prevents a simulation and/or analysis of said circuit if a change in the topology of said circuit is detected.

26. The apparatus of claim 25, wherein said processor:
generates a reference value that is dependent on said topology of said circuit; and
adds said function to said netlist with said reference value as an argument to said function.

27. The apparatus of claim 26, wherein said processor generates said reference value by performing a hash operation on at least a portion of circuit topology parameters of said netlist.

28. The apparatus of claim 26, wherein said processor generates said reference value by:
selecting one or more circuit topology parameters from each line of said netlist; and
using said selected one or more circuit topology of each line of said netlist as inputs to a mathematical algorithm to generate said reference value.

29. The apparatus of claim 28, wherein said processor selects one or more circuit topology parameters from each line of said netlist in a pseudo random fashion.

30. An apparatus comprising a processor to:
determine whether a topology of a circuit described in a netlist has changed;
perform a circuit simulation and/or analysis of said circuit in response to determining that said topology of said circuit has not changed; and
denying a circuit simulation and/or analysis of said circuit in response to determining that said topology of said circuit has changed.

31. The apparatus of claim 30, wherein said processor executes a function in said netlist to cause said determination of whether said topology of said circuit has been changed.

32. The apparatus of claim 31, wherein said function includes a first argument that serves to select circuit topology parameters from each line of said netlist and a second argument that serves as a reference value indicative of an original circuit topology for said netlist.

33. The apparatus of claim 32, wherein said processor determines whether said topology of said circuit has changed by:
using said first argument to select one or more circuit topology parameters from each line of said netlist;
performing a mathematical operation on said selected one or more circuit topology parameters from each line of said netlist to generate a test value; and
comparing said test value with said reference value to determine whether said circuit topology has changed.

34. The apparatus of claim 33, wherein said processor generates a pseudo random number in response to said first argument, said pseudo random number being used to select the number of circuit topology parameters from each of said line of said netlist.

35. The apparatus of claim 33, wherein said mathematical operation comprises a hashing operation.

36. The apparatus of claim 30, wherein said processor:
determines whether the number of components and/or nodes in said netlist is below and/or above a predetermined limit;
performs said circuit simulation and/or analysis of said circuit in response to determining that the number of components and/or nodes in said netlist is below said predetermined limit; and
denying said circuit simulation and/or analysis of said circuit in response to determining that the number of components and/or nodes in said netlist is above said predetermined limit.
